(19) United States
(12) Patent Application Publication
(10) Pub. No.: US 2019/0012074 A1
(43) Pub. Date: Jan. 10, 2019

(54) SYSTEM AND METHOD FOR AUTHENTICATING WITH USER SPECIFIED GRID AND CAPTURING AND COMPARING THE PATTERN START AND END INCLUDING REPEATS

(71) Applicant: SMARTRON INDIA PRIVATE LIMITED, Hyderabad (IN)

(72) Inventors: SUSHITHA THANDAYAN AJAYAN, Bangalore (IN); RAM PRAKASH RUSTAGI, Bangalore (IN); ROHIT RATHI, Bangalore (IN)

(21) Appl. No.: 16/065,806

(22) PCT Filed: Dec. 21, 2016
(86) PCT No.: PCT/IN2016/000293

§ 371 Date: Jun. 23, 2018

(30) Foreign Application Priority Data
Dec. 22, 2015 (IN) 5063/CHE/2015

(51) Int. Cl. G06F 3/0488; G06F 21/84; G06F 3/0482

(52) U.S. Cl. CPC G06F 3/04883; G06F 2221/2149; G06F 3/0482; G06F 21/84

(57) ABSTRACT

The embodiments herein provide a system and method to enable dynamic authentication for unlocking the computing devices. The embodiments also provide a system and method for authenticating a pattern through the preset user-specified grids for capturing and comparing pattern-based authentication systems for accessing computing devices. The users are also enabled to customize a grid depending on preset rules. The system also provides a suggestion of the smallest pattern drawn on a grid. The present dynamic pattern-based authentication system provides enhanced security as compared to conventional pattern-lock systems.

### CROSS-REFERENCE TO RELATED APPLICATION

The embodiments herein claims the priority of the Indian Provisional Patent Application filed on Sep. 22, 2015 and subsequently postdated by 3 months to Dec. 22, 2015 with the number 5063/CHE/2015 and entitled, “SYSTEM AND METHOD FOR AUTHENTICATING WITH USER SPECIFIED GRID AND CAPTURING AND COMPARING THE PATTERN START AND END INCLUDING REPEATS”, and the contents of which are included in entirety as reference herein. The embodiments herein claims the priority of the PCT application with serial number PCT/IN2016/000293 filed on Dec. 21, 2016 and entitled “SYSTEM AND METHOD FOR AUTHENTICATING WITH USER SPECIFIED GRID AND CAPTURING AND COMPARING THE PATTERN START AND END INCLUDING REPEATS”, and the contents of which are included in entirety as reference herein. The present application is a national phase application filed in continuation to the PCT application with serial number PCT/IN2016/000293 filed on Dec. 21, 2016.

### BACKGROUND

### Technical Field

The embodiments herein are generally related to a system and method for providing authentication for accessing a computing device. The embodiments herein are particularly related to a system and method to enable authentication for unlocking computing devices using preset user-defined customized pattern based authentication systems. The embodiments herein are more particularly related to system and method for using preset user-defined customized pattern based authentication systems and enable authentication by determining a path traced by the pattern on a authentication grid. The embodiments herein are also related to a system and method for enabling authentication on a grid-based pattern authentication system by using a same grid-point for a plurality of times in creating the pattern for authentication.

### Description of the Related Art

The widespread use of handheld computing devices has largely enabled mobile computing. With increased use of handheld computing, there comes a need for protecting a computing device from being misused. Multiple authentication methods are available to lock a computing device, such as text password, numeric pass-code, face or voice recognition systems, pattern-lock systems etc.

In the currently available methods of pattern-lock authentication, a grid point is used only once in making a pattern. Due to this, the number of patterns that are drawn on a grid are limited and the security offered by current pattern-lock mechanisms is easily breached. The current pattern-lock authentication systems also use only one preset authentication-grid.

Hence, there is a need for a system and method that enables authentication for unlocking computing devices using preset user-defined customizable grids for pattern based authentication. There is also a need for a system and method to utilize a same grid point for a plurality of times to enable more patterns on an authentication grid to enhance security.

The above mentioned shortcomings, disadvantages and problems are addressed herein and which will be understood by reading and studying the following specification.

### OBJECTS OF THE EMBODIMENTS HEREIN

The primary object of the embodiments herein is to provide a system and method to enable a pattern-based grid authentication for unlocking computing devices using a pattern-based authentication mechanism.

Another objective of the embodiments herein is to provide a system and method for authenticating a pattern through preset user-specified grids for capturing and comparing pattern-based authentication systems for accessing computing devices.

Yet another objective of the embodiments herein is to provide users with a pre-defined list of grid patterns for authenticating an access to the computing devices.

Yet another objective of the embodiments herein is to enable users to define a custom grid pattern for authenticating an access to the computing devices.

Yet another objective of the embodiments herein is to enable a grid-based authentication system to provide a suggestion of the smallest pattern that is drawn on a selected grid.

Yet another objective of the embodiments herein is to present a pattern-based authentication system to provide an enhanced security as compared to conventional pattern-lock systems.

Yet another objective of the embodiments herein is to provide a system and method for enabling authentication on a grid-based pattern authentication system by using a same grid-point for a plurality of times in creating the pattern for authentication.

Yet another objective of the embodiments herein is to provide a system and method for enabling authentication on a preset user-defined authentication grid by determining the path of the pattern and the number of times a grid-point in the authentication grid is used to make the pattern.

Yet another objective of the embodiments herein is to provide a pattern based authentication system for handheld computing devices with an identification of the start and end points of the pattern that is drawn on a grid.

Yet another objective of the embodiments herein is to provide a pattern based authentication system for handheld computing devices with an identification of the frequency and number of attempts made on the authentication system by users.

Yet another objective of the embodiments herein is to provide a pattern based authentication system for handheld computing devices with identification of the direction in which the pattern is made on the authentication grid.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in simplified form as a prelude to the more detailed description that is presented later.

The various embodiments herein provide a system and method to enable authentication for unlocking computing devices. The embodiments also provide a system and method for authenticating a pattern made on an input device of a computing device through preset user-specified grids for capturing and comparing the pattern-based authentication systems for accessing the computing devices.

According to one embodiment herein, a system for authenticating a user for accessing a computing device through a pattern-based authentication mechanism is provided. The system comprises a hardware processor, a memory, a storage database, an enrollment module and an authentication module. The enrollment module is run on the hardware processor and configured to enable a user to create a preset and customized grid based authentication pattern. The information provided by the user is stored in the storage database. The authentication module is run on the hardware processor and configured to enable the user to provide a pattern to the computing device and provides the user with an access to a plurality of contents of the computing device only when the authentication pattern provided by the user matches with a preset authentication pattern stored in the storage database. The authentication module is configured to capture a frequency of use of a grid point in a given authentication pattern and the order of connecting the plurality of grid points in drawing the given authentication pattern.

According to one embodiment herein, the enrollment module comprises a predefined grid display module, a user-defined grid creator module, a grid selector module, a pattern sensor and a feature extraction module. The feature extraction module is connected to the storage database.

According to one embodiment herein, the predefined grid display module is configured to provide a plurality of preset authentication grids to the user for creating an authentication pattern to access the computing device. The predefined grid display module is configured to enable the user to use a same grid point in an authentication grid for a plurality of times in creating an authentication pattern.

According to one embodiment herein, the user-defined grid creator module is configured to enable the user to create a customized authentication grid and a customized authentication pattern to access the computing device, and wherein the user-defined grid creator module is configured to enable the user to use a same grid point in an authentication grid for a plurality of times in creating an authentication pattern.

According to one embodiment herein, the authentication module is configured to capture an order of connecting a plurality of grid points and a number of repeated connecting lines formed between the plurality of grid points.

According to one embodiment herein, the authentication module is configured to capture an order of connecting two grid points. The two grid points are any two successive grid points or any two adjacent grid points or any two grid points. According to one embodiment herein, the storage database is configured to store information in a plurality of devices. The plurality of devices comprises a computing device, a cloud-based server and a remote server.

According to one embodiment herein, a method for authenticating a user for accessing a computing device through a pattern-based authentication mechanism. The method comprises the following steps: creating a preset and customized grid based authentication pattern, where a plurality of information provided by a user is stored in a storage database; and, enabling a user to provide a pattern to a computing device and provide the user with an access to the contents of the computing device only when the authentication pattern provided by the user matches with preset authentication patterns stored in the database.

According to one embodiment herein, an enrollment module is configured to comprise a predefined grid display module, a user-defined grid creator module, a grid selector module, a touch sensor, a pattern sensor and a feature extraction module that is connected to the database storage, and wherein the predefined grid display module provides a plurality of preset authentication grids to the user for creating an authentication pattern to access the computing device, and wherein the predefined grid display module enables a user to use a same grid point in an authentication grid for a plurality of times in creating an authentication pattern.

According to one embodiment herein, the authentication module is configured to capture an order of connecting a plurality of grid points, and a number of repeated connecting lines formed between the plurality of grid points.

According to one embodiment herein, the authentication module is configured to capture an order of connecting two grid points. The two grid points are any two successive grid points or any two adjacent grid points or any two grid points. According to one embodiment herein, a user-defined grid creator enables a user to create customized authentication aids and authentication patterns to access the computing device. The user-defined grid creator enables a user to use a same grid point in an authentication grid for a plurality of times in creating an authentication pattern.

According to one embodiment herein, the storage database is configured to store information in a plurality of devices such as a computing device, a cloud-based server and a remote server.

According to one embodiment herein, pattern based authentication module is provided. The authentication module comprises an authentication grid, which comprises a plurality of grid points. A grid point in a pattern is used a plurality of times and not restricted to just once. The order of drawing the pattern and the order in which grid patterns are linked are taken into the account for authentication. When a same grid point is used multiple times, the order in which the point is connected from previous grid point and to the next grid point is taken into account and is considered a part of authentication information.

According to one embodiment herein, a system for authenticating a user for accessing a computing device through a pattern-based authentication mechanism is provided. The system comprises a hardware processor, a memory, a database storage, an enrollment module and an authentication module. The enrollment module enables a user to create a preset and customized grid based authentication pattern and the information provided by a user is stored in a database storage. The authentication module enables a user to provide a pattern to a computing device and provides the user with an access to the contents of the computing device only when the authentication pattern provided by the user matches with preset authentication patterns stored in the database.

According to one embodiment herein, an enrollment module comprises a predefined grid display module, a user-defined grid creator, a grid selector, a pattern sensor and a feature extraction module that is connected to the database storage. The predefined grid display module provides a plurality of preset authentication grids to the user for creating an authentication pattern to access the computing device. The predefined grid display module enables a user to use a same grid point in an authentication grid for a plurality of times in creating an authentication pattern.

According to one embodiment herein, the user-defined grid creator enables a user to create customized authentication grids and authentication patterns to access the computing device. The user-defined grid creator enables a user to use a same grid point in an authentication grid for a plurality of times in creating an authentication pattern.

According to one embodiment herein, the database storage is configured to store information in a plurality of devices such as a computing device, a cloud-based server and a remote server.

According to one embodiment herein, a method for authenticating a user for accessing a computing device through a pattern-based authentication mechanism. The method comprises creating a preset and customized grid based authentication pattern, where the information provided by a user is stored in a database storage; and, enabling a user to provide a pattern to a computing device and provide the user with an access to the contents of the computing device only when the authentication pattern provided by the user matches with preset authentication patterns stored in the database.

According to one embodiment herein, an authentication system for unlocking the computing devices is provided. The system comprises the preset user-specified grids for capturing and comparing a pattern-based authentication. The users are provided with options to customize a grid depending on the preset rules. The system also provides a suggestion of the smallest pattern that is drawn on a selected grid.

According to one embodiment herein, the authentication system is enabled to use a same grid-point in an authentication grid for a plurality of times in creating a pattern for authentication. The system is configured to identify the direction in which a pattern is made and the number of times a same grid point is utilized in creating a pattern. The system is also enabled to create a plurality of different authentication patterns using a same set of grid points on an authentication grid.

According to one embodiment herein, the system that is configured to identify the start and end points of the pattern that is drawn on a grid is provided for authenticating the hand held computing devices.

According to one embodiment herein, the system is configured to identify the frequency and number of attempts made on the authentication system by users.

According to one embodiment herein, the system is configured to identify the direction in which the pattern is created/drawn on the authentication grid.

According to one embodiment herein, a dynamic pattern-based authentication system is provided. The system comprises a User, Enrollment module, Authentication module, Database Storage and Result module. The enrollment module comprises Predefined Grid Display, Grid Selector, User-defined Grid Creator, Pattern Sensor and Feature Extraction module. The Feature Extraction module is connected to a Storage Database. The authentication module comprises Grid Selector module, Draw Pattern module, Image Extraction module and Matching module. The Matching module is connected to the Result module.

According to one embodiment herein, a method of authenticating a mobile computing device dynamically is provided. The processes comprise the following steps: A user is provided with a pre-defined list of grid patterns to choose from. The user is also enabled to define a custom grid pattern of one's own choice. Once the user chooses a new grid pattern, the device records the selected grid pattern and displays the grid on the screen of computing device. The user draws a pattern on the custom grid on the device screen and the drawn pattern is recorded in the device. When the computing device is switched on, the user identifies the preset grid pattern and the pattern for the corresponding grid by redrawing the pattern to unlock the screen. The device is unlocked only if the pattern and grid match with the preset grid pattern. In addition to the above, the device suggests a smallest pattern to be drawn on the selected grid.

According to one embodiment herein, a plurality of methods are provided to authenticate an authentication grid using a same set of grid points. An authentication grid comprises a plurality of grid points. A same grid point is used a plurality of times to create a pattern, and a same set of grid points are used to create a plurality of patterns.

According to one embodiment herein, a computer implemented method comprising instructions stored on a non-transitory computer readable storage medium and executed on a system provided with a hardware processor and memory for authenticating a user for accessing a computing device through a pattern-based authentication mechanism. The method comprises the following steps: creating a preset and customized grid based authentication pattern, where a plurality of information provided by a user is stored in a storage database; and, enabling a user to provide a pattern to a computing device and provide the user with an access to the contents of the computing device only when the authentication pattern provided by the user matches with preset authentication patterns stored in the database.

According to one embodiment herein, an enrollment module is configured to comprise a predefined grid display module, a user-defined grid creator module, a grid selector module, a touch sensor, a pattern sensor and a feature extraction module that is connected to the database storage, and wherein the predefined grid display module provides a plurality of preset authentication grids to the user for creating an authentication pattern to access the computing device, and wherein the predefined grid display module enables a user to use a same grid point in an authentication grid for a plurality of times in creating an authentication pattern.

According to one embodiment herein, the authentication module is configured to capture an order of connecting a plurality of grid points, and a number of repeated connecting lines formed between the plurality of grid points.

According to one embodiment herein, the authentication nodule is configured to capture an order of connecting two grid points. The two grid points are any two successive grid points or any two adjacent grid points or any two grid points. According to one embodiment herein, a user-defined grid creator enables a user to create customized authentication grids and authentication patterns to access the computing device. The user-defined grid creator enables a user to use a same grid point in an authentication grid for a plurality of times in creating an authentication pattern.

According to one embodiment herein, the storage database is configured to store information in a plurality of devices such as a computing device, a cloud-based server and a remote server.

According to one embodiment herein, a pattern based authentication module is provided. The authentication module comprises an authentication grid, which comprises a plurality of grid points. A grid point in a pattern is used a plurality of times and not restricted to just once. The order of drawing the pattern and the order in which grid patterns are linked are taken into the account for authentication. When a same grid point is used multiple times, the order in which the point is connected from previous grid point and to the next grid point is taken into account and is considered a part of authentication information.

According to one embodiment herein, a system for authenticating a user for accessing a computing device through a pattern-based authentication mechanism is provided. The system comprises a hardware processor, a memory, a database storage, an enrollment module and an authentication module. The enrollment module enables a user to create a preset and customized grid based authentication pattern and the information provided by a user is stored in a database storage. The authentication module enables a user to provide a pattern to a computing device and provides the user with an access to the contents of the computing device only when the authentication pattern provided by the user matches with preset authentication patterns stored in the database.

According to one embodiment herein, an enrollment module comprises a predefined grid display module, a user-defined grid creator, a grid selector, a pattern sensor and a feature extraction module that is connected to the database storage. The predefined grid display module provide a plurality of preset authentication grids to the user for creating an authentication pattern to access the computing device. The predefined grid display module enables a user to use a same grid point in an authentication grid for a plurality of times in creating an authentication pattern.

According to one embodiment herein, the user-defined grid creator enables a user to create customized authentication grids and authentication patterns to access the computing device. The user-defined grid creator enables a user to use a same grid point in an authentication grid for a plurality of times in creating an authentication pattern.

According to one embodiment herein, the database storage is configured to store information in a plurality of devices such as a computing device, a cloud-based server and a remote server.

According to one embodiment herein, a method for authenticating a user for accessing a computing device through a pattern-based authentication mechanism. The method comprises creating a preset and customized grid based authentication pattern, where the information provided by a user is stored in a database storage; and, enabling a user to provide a pattern to a computing device and provide the user with an access to the contents of the computing device only when the authentication pattern provided by the user matches with preset authentication patterns stored in the database.

According to one embodiment herein, an authentication system for unlocking the computing devices is provided. The system comprises the preset user-specified grids for capturing and comparing a pattern-based authentication The users are provided with options to customize a grid depending on the preset rules. The system also provides a suggestion of the smallest pattern that is drawn on a selected grid.

According to one embodiment herein, the authentication system is enabled to use a same grid-point in an authentication grid for a plurality of times in creating a pattern for authentication. The system is configured to identify the direction in which a pattern is made and the number of times a same grid point is utilized in creating a pattern. The system is also enabled to create a plurality of different authentication patterns using a same set of grid points on an authentication grid.

According to one embodiment herein, the system that is configured to identify the start and end points of the pattern that is drawn on a grid is provided for authenticating the hand held computing devices.

According to one embodiment herein, the system is configured to identify the frequency and number of attempts made on the authentication system by users.

According to one embodiment herein, the system is configured to identify the direction in which the pattern is created/drawn on the authentication grid.

According to one embodiment herein, a dynamic pattern-based authentication system is provided. The system comprises a User, Enrollment module, Authentication module, Database Storage and Result module. The enrollment module comprises Predefined Grid Display, Grid Selector, User-defined Grid Creator, Pattern Sensor and Feature Extraction module. The Feature Extraction module is connected to a Storage Database. The authentication module comprises Grid Selector module, Draw Pattern module, Image Extraction module and Matching module. The Matching module is connected to the Result module.

According to one embodiment herein, a method of authenticating a mobile computing device dynamically is provided. The processes comprise the following steps: A user is provided with a pre-defined list of grid patterns to choose from. The user is also enabled to define a custom grid pattern of one's own choice. Once the user chooses a new grid pattern, the device records the selected grid pattern and displays the grid on the screen of computing device. The user draws a pattern on the custom grid on the device screen and the drawn pattern is recorded in the device. When the computing device is switched on, the user identifies the preset grid pattern and the pattern for the corresponding grid by redrawing the pattern to unlock the screen. The device is unlocked only if the pattern and grid match with the preset grid pattern. In addition to the above, the device suggests a smallest pattern to be drawn on the selected grid.

According to one embodiment herein, a plurality of methods are provided to authenticate an authentication grid using a same set of grid points. An authentication grid comprises a plurality of grid points. A same grid point is used a plurality of times to create a pattern, and a same set of grid points are used to create a plurality of patterns.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a dynamic pattern-based authentication system, according to one embodiment herein.

FIG. 2 illustrates a flow chart explaining a method of authenticating a mobile computing device dynamically using pattern based authentication mechanism, according to one embodiment herein.

FIG. 3a-3e illustrates a schematic representation of a plurality of ways of drawings authentication grid using a same set of grid points, according to one embodiment herein.

Although the specific features of the present invention are shown in some drawings and not in others. This is done for convenience only as each feature may be combined with any or all of the other features in accordance with the embodiments herein.

### DETAILED DESCRIPTION OF THE EMBODIMENTS

in the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a system and method to enable authentication for unlocking computing devices. The embodiments also provide a system and method for authenticating a pattern made on an input device of a computing device through preset user-specified grids for capturing and comparing the pattern-based authentication systems for accessing the computing devices.

According to one embodiment herein, a system for authenticating a user for accessing a computing device through a pattern-based authentication mechanism is provided. The system comprises a hardware processor, a memory, a storage database, an enrollment module and an authentication module. The enrollment module is run on the hardware processor and configured to enable a user to create a preset and customized grid based authentication pattern. The information provided by the user is stored in the storage database. The authentication module is run on the hardware processor and configured to enable the user to provide a pattern to the computing device and provides the user with an access to a plurality of contents of the computing device only when the authentication pattern provided by the user matches with a preset authentication pattern stored in the storage database. The authentication module is configured to capture a frequency of use of a grid point in a given authentication pattern and the order of connecting the plurality of grid points in drawing the given authentication pattern.

According to one embodiment herein, the enrollment module comprises a predefined grid display module, a user-defined grid creator module, a grid selector module, a pattern sensor and a feature extraction module. The feature extraction module is connected to the storage database.

According to one embodiment herein, the predefined grid display module is configured to provide a plurality of preset authentication grids to the user for creating an authentication pattern to access the computing device. The predefined grid display module is configured to enable the user to use a same grid point in an authentication grid for a plurality of times in creating an authentication pattern.

According to one embodiment herein, the user-defined grid creator module is configured to enable the user to create a customized authentication grid and a customized authentication pattern to access the computing device, and wherein the user-defined grid creator module is configured to enable the user to use a same grid point in an authentication grid for a plurality of times in creating an authentication pattern.

According to one embodiment herein, the authentication module is configured to capture an order of connecting a plurality of grid points and a number of repeated connecting lines formed between the plurality of grid points.

According to one embodiment herein, the authentication module is configured to capture an order of connecting two grid points. The two grid points are any two successive grid points or any two adjacent grid points or any two grid points. According to one embodiment herein, the storage database is configured to store information in a plurality of devices. The plurality of devices comprises a computing device, a cloud-based server and a remote server.

According to one embodiment herein, a method for authenticating a user for accessing a computing device through a pattern-based authentication mechanism. The method comprises the following steps: creating a preset and customized grid based authentication pattern, where a plurality of information provided by a user is stored in a storage database; and, enabling a user to provide a pattern to a computing device and provide the user with an access to the contents of the computing device only when the authentication pattern provided by the user matches with preset authentication patterns stored in the database.

According to one embodiment herein, an enrollment module is configured to comprise a predefined grid display module, a user-defined grid creator module, a grid selector module, a touch sensor, a pattern sensor and a feature extraction module that is connected to the database storage, and wherein the predefined grid display module provides a plurality of preset authentication grids to the user for creating an authentication pattern to access the computing device, and wherein the predefined grid display module enables a user to use a same grid point in an authentication grid for a plurality of times in creating an authentication pattern.

According to one embodiment herein, the authentication module is configured to capture an order of connecting a plurality of grid points, and a number of repeated connecting lines formed between the plurality of grid points.

According to one embodiment herein, the authentication module is configured to capture an order of connecting two grid points. The two grid points are any two successive grid points or any two adjacent grid points or any two grid points. According to one embodiment herein, a user-defined grid creator enables a user to create customized authentication grids and authentication patterns to access the computing device. The user-defined grid creator enables a user to use a same grid point in an authentication grid for a plurality of times in creating an authentication pattern.

According to one embodiment herein, the storage database is configured to store information in a plurality of devices such as a computing device, a cloud-based server and a remote server.

According to one embodiment herein, a pattern based authentication module is provided. The authentication module comprises an authentication grid, which comprises a plurality of grid points. A grid point in a pattern is used a plurality of times and not restricted to just once. The order of drawing the pattern and the order in which grid patterns are linked are taken into the account for authentication. When a same grid point is used multiple times, the order in which the point is connected from previous grid point and to the next grid point is taken into account and is considered a part of authentication information.

According to one embodiment herein, a system for authenticating a user for accessing a computing device through a pattern-based authentication mechanism is provided. The system comprises a hardware processor, a memory, a database storage, an enrollment module and an authentication module. The enrollment module enables a user to create a preset and customized grid based authentication pattern and the information provided by a user is stored in a database storage. The authentication module enables a user to provide a pattern to a computing device and provides the user with an access to the contents of the computing device only when the authentication pattern provided by the user matches with preset authentication patterns stored in the database.

According to one embodiment herein, an enrollment module comprises a predefined grid display module, a user-defined grid creator, a grid selector, a pattern sensor and a feature extraction module that is connected to the database storage. The predefined grid display module provides a plurality of preset authentication grids to the user for creating an authentication pattern to access the computing device. The predefined grid display module enables a user to use a same grid point in an authentication grid for a plurality of times in creating an authentication pattern.

According to one embodiment herein, the user-defined grid creator enables a user to create customized authentication grids and authentication patterns to access the computing device. The user-defined grid creator enables a user to use a same grid point in an authentication grid for a plurality of times in creating an authentication pattern.

According to one embodiment herein, the database storage is configured to store information in a plurality of devices such as a computing device, a cloud-based server and a remote server.

According to cane embodiment herein, a method for authenticating a user for accessing a computing device through a pattern-based authentication mechanism. The method comprises creating a preset and customized grid based authentication pattern, where the information provided by a user is stored in a database storage; and, enabling a user to provide a pattern to a computing device and provide the user with an access to the contents of the computing device only when the authentication pattern provided by the user matches with preset authentication patterns stored in the database.

According to one embodiment herein, an authentication system for unlocking the computing devices is provided. The system comprises the preset user-specified grids for capturing and comparing a pattern-based authentication. The users are provided with options to customize a grid depending on the preset rules. The system also provides a suggestion of the smallest pattern that is drawn on a selected grid.

According to one embodiment herein, the authentication system is enabled to use a same grid-point in an authentication grid for a plurality of times in creating a pattern for authentication. The system is configured to identify the direction in which a pattern is made and the number of times a same grid point is utilized in creating a pattern. The system is also enabled to create a plurality of different authentication patterns using a same set of grid points on an authentication grid.

According to one embodiment herein, the system that is configured to identify the start and end points of the pattern that is drawn on a grid is provided for authenticating the hand held computing devices.

According to one embodiment herein, the system is configured to identify the frequency and number of attempts made on the authentication system by users.

According to one embodiment herein, the system is configured to identify the direction in which the pattern is created/drawn on the authentication grid.

According to one embodiment herein, a dynamic pattern-based authentication system is provided. The system comprises a User, Enrollment module, Authentication module, Database Storage and Result module. The enrollment module comprises Predefined Grid Display, Grid Selector, User-defined Grid Creator, Pattern Sensor and Feature Extraction module. The Feature Extraction module is connected to a Storage Database. The authentication module comprises Grid Selector module, Draw Pattern module, Image Extraction module and Matching module. The Matching module is connected to the Result module.

According to one embodiment herein, a method of authenticating a mobile computing device dynamically is provided. The processes comprise the following steps: A user is provided with a pre-defined list of grid patterns to choose from. The user is also enabled to define a custom grid pattern of one's own choice. Once the user chooses a new grid pattern, the device records the selected grid pattern and displays the grid on the screen of computing device. The user draws a pattern on the custom grid on the device screen and the drawn pattern is recorded in the device. When the computing device is switched on, the user identifies the preset grid pattern and the pattern for the corresponding grid by redrawing the pattern to unlock the screen. The device is unlocked only if the pattern and grid match with the preset grid pattern. In addition to the above, the device suggests a smallest pattern to be drawn on the selected grid.

According to one embodiment herein, a plurality of methods are provided to authenticate an authentication grid using a same set of grid points. An authentication grid comprises a plurality of grid points. A same grid point is used a plurality of times to create a pattern, and a same set of grid points are used to create a plurality of patterns.

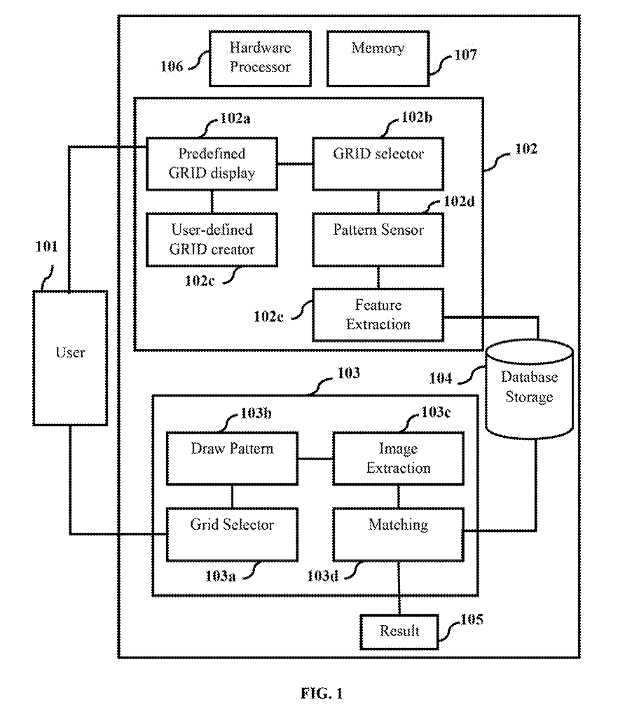

FIG. 1 illustrates a block diagram of a dynamic pattern-based authentication system. The system comprises a Hardware Processor 106, Memory 107, User 101, Enrollment module 102, Authentication module 103, Database Storage 104 and Result module 105. Enrollment module 102 comprises Predefined Grid Display 102a, Grid Selector 102b, User-defined Grid Creator 102c, Pattern Sensor 102d and Feature Extraction module 102e. The Feature Extraction module 102e is connected to Storage Database 104, Authentication module 103 comprises Grid Selector module 103a, Pattern Draw module 103b, Image Extraction module 103c and Matching module 103d. The Matching module 103d is connected to Result module 105.

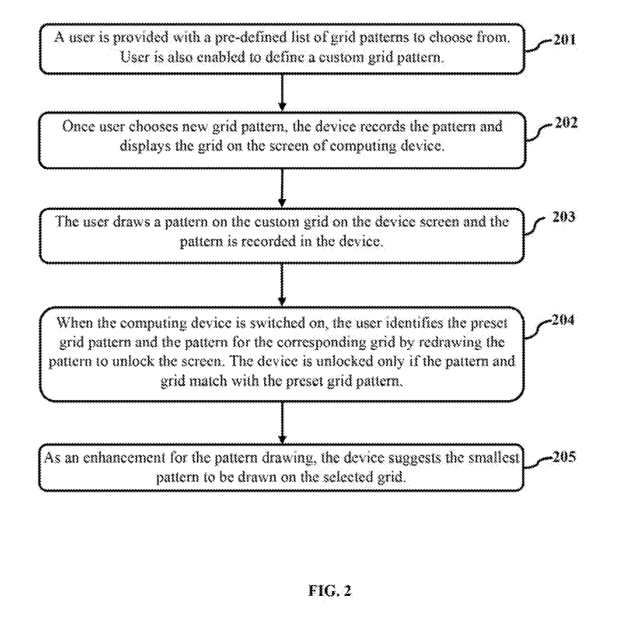

FIG. 2 illustrates a flow chart explaining a method of authenticating a mobile computing device dynamically using pattern based authentication mechanism. The processes comprise following steps. A user is provided with a pre-defined list of grid patterns to choose from. The user is also enabled to define a custom grid pattern (201). Once the user chooses new grid pattern, the device records the pattern and displays the grid on the screen of computing device (202). The user draws a pattern on the custom grid on the device screen and the pattern is recorded in the device (203). When the computing device is switched on, the user identifies the preset grid pattern and the pattern for the corresponding grid by redrawing the pattern to unlock the screen. The device is unlocked only if the pattern and grid match with that of the preset grid pattern (204). As an enhancement for the pattern drawing, the device suggests the smallest pattern to be drawn on the selected grid (205).

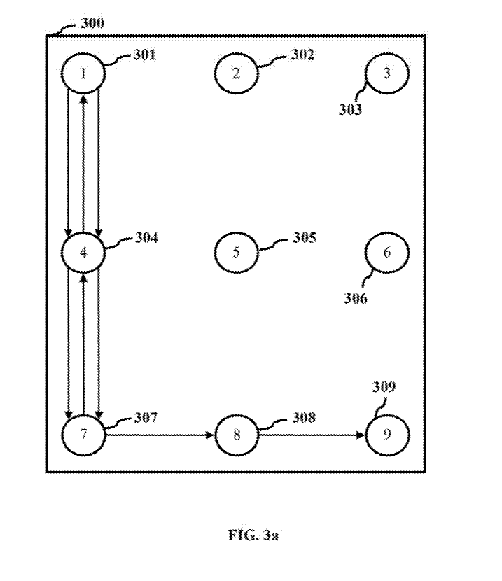

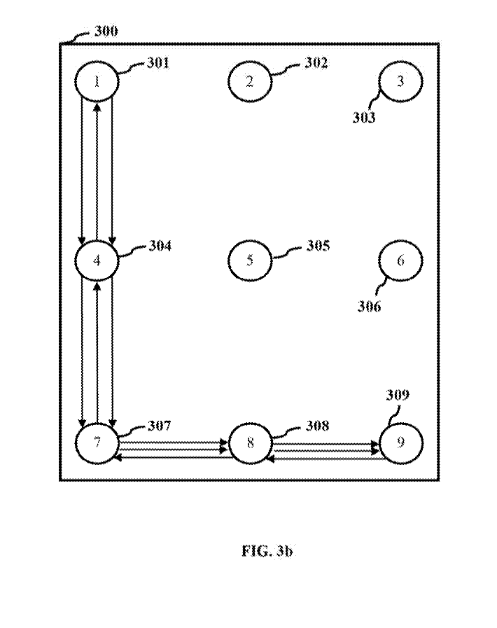

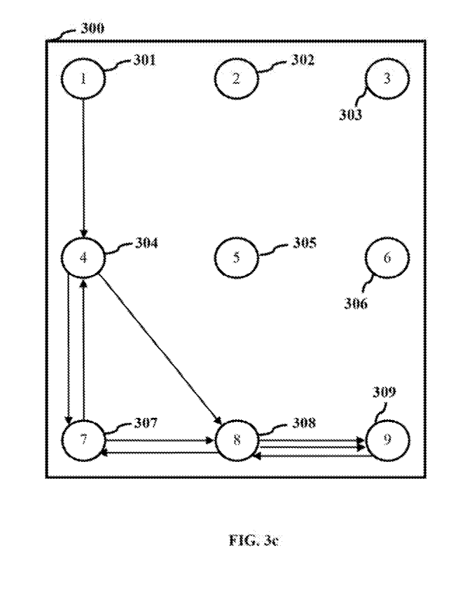

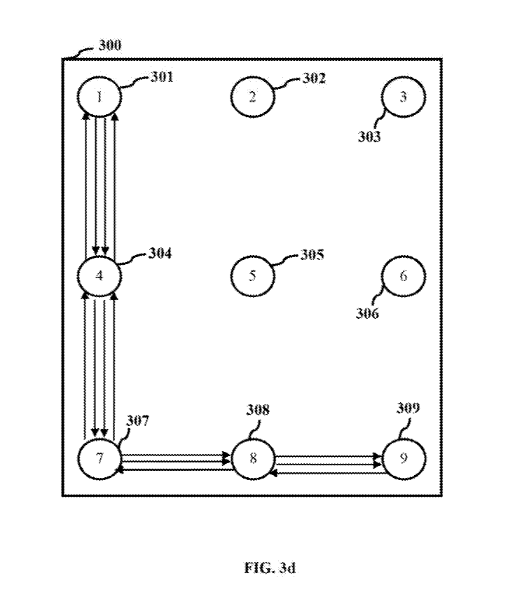

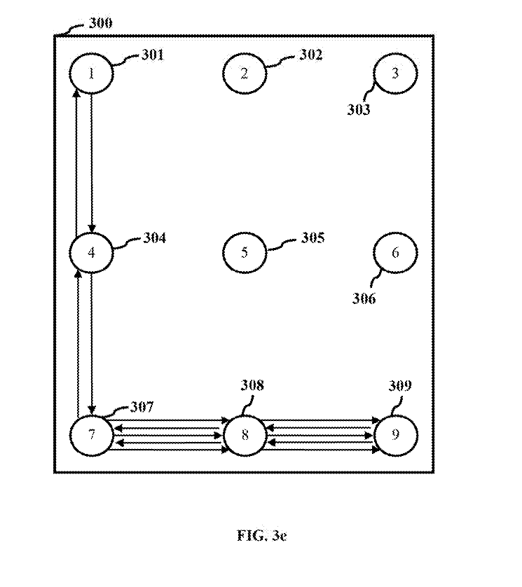

FIG. 3a-3e illustrates a plurality of methods to authenticate an authentication grid using a same set of grid points. An Authentication Grid 300 comprises a plurality of Grid Points 301, 302 . . . , 309. A same grid point is used a plurality of times to create a pattern, and a same set of grid points are used to create a plurality of patterns. When a grid point is used multiple times, the order in which a grid point is connected from a previous grid point and to the next grid point is a part of unique authentication information. FIG. 3a-3e illustrate a plurality of authentication patterns formed using grid points 301, 304, 307, 308 and 309. FIG. 3a illustrates an authentication pattern formed by a combination of the grind points 301, 304, 307, 308 and 309 in the following order: 301-304-307-304-301-304-307-308-309. FIG. 3b illustrates an authentication pattern formed by a combination of the grind points 301, 304, 307, 308 and 309 in the following order: 301-304-307-304-301-304-307-308-309-308-307-308-309. FIG. 3c illustrates an authentication pattern formed by a combination of the grind points 301, 304, 307, 308 and 309 in the following order: 301-304-307-304-308-309-308-307-308-309. FIG. 3d illustrates an authentication pattern formed by a combination of the grind points 301, 304, 307, 308 and 309 in the following order: 307-304-301-304-307-304-301-304-307-308-309-308-307-308-309. FIG. 3e illustrates an authentication pattern formed by a combination of the grind points 301, 304, 307, 308 and 309 in the following order: 307-308-309-308-307-304-301-304-307-308-309-308-307-308-309.

Therefore, the embodiments herein provide a system and method to enable dynamic authentication for unlocking computing devices. The embodiments also provide a system and method for authenticating a pattern through the preset user-specified grids for capturing and comparing pattern-based authentication systems for accessing the computing devices. The currently available methods of pattern-lock authentication do not offer dynamic authentication. Due to this, the security offered by current pattern-lock mechanisms is easily breached. The embodiments provide a system and method that enables a dynamic authentication for unlocking the computing devices. The present dynamic pattern-based authentication system provides an enhanced security as compared to conventional pattern lock systems.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be the to fall there between.

What is claimed is:

1. A system for authenticating a user for accessing a computing device through a pattern-based authentication mechanism, the system comprising:
a hardware processor;
a memory;
a storage database;
an enrolment module, wherein the enrolment module is run on the hardware processor and configured to enable a user to create a preset and customized grid based authentication pattern, and wherein the information provided by the user is stored in the storage database; and,
an authentication module, wherein the authentication module is run on the hardware processor and configured to enable the user to provide a pattern to the computing device and provides the user with an access to a plurality of contents of the computing device only when the authentication pattern provided by the user matches with a preset authentication pattern stored in the storage database, and wherein the authentication module is configured to capture a frequency of use of a grid point in a given authentication pattern and the order of connecting the plurality of grid points in drawing the given authentication pattern.

2. The system according to claim 1, wherein the enrollment module comprises a predefined grid display module, a user-defined grid creator module, a grid selector module, a pattern sensor and a feature extraction module, and wherein the feature extraction module is connected to the storage database.

3. The system according to claim 2, wherein the predefined grid display module is configured to provide a plurality of preset authentication grids to the user for creating an authentication pattern to access the computing device, and wherein the predefined grid display module is configured to enable the user to use a same grid point in an authentication grid for a plurality of times in creating an authentication pattern.

4. The system according to claim 2, wherein the user-defined grid creator module is configured to enable the user to create a customized authentication grid and a customized authentication pattern to access the computing device, and wherein the user-defined grid creator module is configured to enable the user to use a same grid point in an authentication grid for a plurality of times in creating an authentication pattern.

5. The system according to claim 1, wherein the authentication module is configured to capture an order of connecting a plurality of grid points, and a number of repeated connecting lines formed between the plurality of grid points.

6. The system according to claim 1, wherein the authentication module is configured to capture an order of connecting two grid points, and wherein two grid points are any two successive grid points or any two adjacent grid points or any two grid points.

7. The system according to claim 1, wherein the storage database is configured to store information in a plurality of devices, and wherein the plurality of devices comprises a computing device, a cloud-based server and a remote server.

8. A computer implemented method comprising instructions stored on a non-transitory computer readable storage medium and executed on a system provided with a hardware processor and a memory for authenticating a user for accessing a computing device through a pattern-based authentication mechanism, the method comprising:
creating a preset and customized grid based authentication pattern, and wherein a plurality of information provided by a user is stored in a storage database; and,
enabling a user to provide a pattern to a computing device and provide the user with an access to the contents of the computing device only whet the authentication pattern provided by the user matches with preset authentication patterns stored in the database.

9. The method according to claim 8, wherein an enrollment module is configured to comprise a predefined grid display module, a user-defined grid creator module, a grid selector module, a touch sensor, a pattern sensor and a feature extraction module that is connected to the database storage, and wherein the predefined grid display module provides a plurality of preset authentication grids to the user for creating an authentication pattern to access the computing device, and wherein the predefined grid display module enables a user to use a same grid point in an authentication grid for a plurality of times in creating an authentication pattern.

10. The method according to claim 8, wherein the authentication module is configured to capture an order of connecting a plurality of grid points, and a number of repeated connecting lines formed between the plurality of grid points.

11. The method according to claim 8, wherein the authentication module is configured to capture an order of connecting two grid points, and wherein two grid points are any two successive grid points or any two adjacent grid points or any two grid points.

12. The method according to claim 8, wherein a user-defined grid creator enables a user to create customized authentication grids and authentication patterns to access the computing device, and wherein the user-defined grid creator enables a user to use a same grid point in an authentication grid for a plurality of times in creating an authentication pattern.

13. The method according to claim 8, wherein the storage database is configured to store information in a plurality of devices such as a computing device, a cloud-based server and a remote server.
